(19) United States
(12) Patent Application Publication
(10) Pub. No.: US 2026/0304051 A1
(43) Pub. Date: Oct. 1, 2026

(54) SYSTEMS AND METHODS FOR FITTING A HEARING DEVICE BASED ON A PITCH ANGLE OF THE HEARING DEVICE

(71) Applicant: SONOVA AG, Staefa (CH)

(72) Inventors: Markus Leuthold, Staefa (CH); Kevin Stehrenberger, Fehraltorf (CH); Jeremias Perren, lllnau (CH); Axel Schlesinger, Wolfhausen (CH); Hans-Ueli Roeck, Hombrechtikon (CH)

(21) Appl. No.: 19/092,600

(22) Filed: Mar. 27, 2025

(51) Int. Cl. H04R 25/00

(52) U.S. Cl. CPC H04R 25/70; H04R 2225/021

(57) ABSTRACT

An illustrative fitting system is provided for determining a target length of a sound delivery system (SDS) from a hearing device, the SDS configured to connect a behind-the-ear (BTE) unit positioned behind an ear of an end user with an earpiece when worn by the end user. The fitting system includes a position sensor included in the BTE unit and having a gravity direction detector configured to generate position data representative of an orientation of the BTE unit relative to a gravity direction, a processing unit communicatively coupled to the position sensor and configured to determine, based on the position data, when a pitch angle of the BTE unit is within a threshold range, and a communication means configured to indicate when the pitch angle of the BTE unit is within the threshold range for determining the target length of the SDS.

### BACKGROUND INFORMATION

Hearing devices may be used to improve the hearing capability or communication capability of an end user, for instance by compensating a hearing loss of a hearing-impaired user, in which case the hearing device is commonly referred to as a hearing instrument such as a hearing aid or hearing prosthesis. A hearing device may also be used to output sound based on an audio signal which may be communicated by a wire or wirelessly to the hearing device. A hearing device may also be used to reproduce a sound in an end user's ear canal detected by an input transducer such as a microphone or a microphone array. The reproduced sound may be amplified to account for a hearing loss, such as in a hearing instrument, or may be output without accounting for a hearing loss, for instance to provide for a faithful reproduction of detected ambient sound and/or to add audio features of an augmented reality in the reproduced ambient sound, such as in a hearable. A hearing device may also provide for a situational enhancement of an acoustic scene, e.g. beamforming and/or active noise cancelling (ANC), with or without amplification of the reproduced sound. A hearing device may also be implemented as a hearing protection device, such as an earplug, configured to protect the user's hearing.

Different types of hearing devices configured to be worn at an ear include earbuds, earphones, hearables, and hearing instruments such as receiver-in-the-canal (RIC) hearing aids, behind-the-ear (BTE) hearing aids, in-the-ear (ITE) hearing aids, invisible-in-the-canal (IIC) hearing aids, completely-in-the-canal (CIC) hearing aids, cochlear implant systems configured to provide electrical stimulation representative of audio content to an end user, a bimodal hearing system configured to provide both amplification and electrical stimulation representative of audio content to an end user, or any other suitable hearing prostheses. A hearing system comprising two hearing devices configured to be worn at different ears of the end user is sometimes also referred to as a binaural hearing device. A hearing system may also comprise a hearing device, e.g., a single monaural hearing device or a binaural hearing device, and a user device, e.g., a smartphone and/or a smartwatch, communicatively coupled to the hearing device.

Some hearing devices are also increasingly equipped with different sensor types. Traditionally, those sensors often include an input transducer to detect a sound, e.g., a sound detector such as a microphone or a microphone array. An amplified and/or signal processed version of the detected sound may then be outputted to the user by an output transducer, e.g., a receiver, loudspeaker, or electrodes to provide electrical stimulation representative of the outputted signal. In an effort to provide the user with even more information about himself and/or the ambient environment, various other sensor types are progressively implemented, in particular sensors which are not directly related to the sound reproduction and/or amplification function of the hearing device. Those sensors include position sensors, such as accelerometers, allowing to monitor movements of the hearing device.

Many hearing devices are configured to be worn at least partially behind the ear of the user. For example, a hearing device may include a BTE portion adapted to be worn behind the ear of the end user that is interconnected with an earpiece adapted to be worn at an entrance of an ear canal by a sound delivery system (SDS). Accordingly, the BTE portion may include one or more microphones configured to detect sound that is transmitted to the end user through the SDS and earpiece. The SDS may be provided in a variety of lengths such that, in some scenarios, the hearing device is fitted to the user by a hearing care professional (HCP) during a fitting procedure to select the length of the SDS. As an illustrative example, during a typical fitting procedure, the HCP may hold a simplistic measurement tool, such as a cardboard marker, at the ear of the end user to measure one or more physical features of the user. Based on the measurements and/or one or more other factors (e.g., a type of the hearing device, other physical features of the end user, preferences of the end user, etc.), the HCP may select the length of the SDS.

In some instances, the fitting of the hearing device may be difficult and/or prone to errors, particularly for less-experienced HCPs. For example, the measurements of the user's physical features may be performed without consideration of the position of the BTE portion of the hearing device behind the ear of the user, which may result in the selection of an improper length of the SDS (e.g., the length of the SDS may be too long and/or too short). Because the length of the SDS influences the position of the BTE portion of the hearing device behind the ear of the end user, such selection of an improper length of the SDS may cause the BTE portion to be improperly positioned behind the ear of the end user (e.g., the BTE portion may be positioned too far back in instances where the SDS length is too long and/or the BTE portion may be positioned too far forward in instances where the SDS length is too short). Moreover, improper positioning of the BTE portion of the hearing device may result in decreased performance of the hearing device (e.g., microphones included in the BTE unit may not be properly positioned to sufficiently detect sound and/or perform beamformer techniques).

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows an illustrative implementation of a hearing system that may be fitted to an end user.

FIG. 2 shows another illustrative implementation of a hearing system that may be fitted to an end user.

FIGS. 3A and 3B show an illustrative implementation of a hearing device implemented as an RIC hearing device.

FIGS. 4A and 4B show another illustrative implementation of a hearing device that includes a beamformer.

FIG. 5 shows an illustrative implementation of a fitting system.

FIG. 6 shows an illustrative method for indicating a target length of an SDS.

FIGS. 7A and 7B show illustrative implementations of a visual indicator device.

FIGS. 8A and 8B show implementations in which a visual indicator device is coupled with a BTE unit and positioned at ear of an end user.

FIG. 9 shows another illustrative implementation of a fitting system.

FIG. 10 shows an illustrative implementation of a user interface view.

FIG. 11 shows another illustrative method for indicating a target length of an SDS.

FIG. 12 shows an illustrative computing device.

### DETAILED DESCRIPTION

Systems and methods are described herein for fitting a hearing device based on a pitch angle of the hearing device. The pitch angle is the angle between the microphone axis/beamformer direction and the viewing direction of the hearing-impaired end user, i.e., a horizontal plane that is oriented substantially perpendicularly relative to the gravity direction of the earth's gravitational field. For example, an illustrative fitting system for determining a target length of an SDS from a hearing device, the SDS configured to connect a BTE unit positioned behind an ear of an end user with an earpiece when worn by the end user, includes a position sensor included in the BTE unit and having a gravity direction detector configured to generate position data representative of an orientation of the BTE unit relative to the gravity direction (towards the middle of the earth), a processing unit communicatively coupled to the position sensor and configured to determine, based on the position data, when a pitch angle of the BTE unit is within a threshold range, and a communication means configured to indicate when the pitch angle of the BTE unit is within the threshold range for determining the target length of the SDS.

In some examples, a visual indicator is included in the BTE unit, such as a light emitting diode (LED), configured to emit light when the BTE unit is positioned relative to the ear such that the pitch angle of the BTE unit is within the threshold range. Accordingly, the visual indicator may provide a notification to the HCP when the pitch angle is within the threshold range.

In some examples, the communication means comprises a visual indicator device releasably coupled with the BTE unit and having a scale depicting a plurality of increments aligned along the scale that each represent a specific SDS length. Additionally or alternatively, the communication means may comprise a user interface communicatively coupled to the BTE unit such that one or more processors of the user interface are configured to determine information associated with the pitch angle of the BTE unit (e.g., the pitch angle of the BTE unit, a difference between the pitch angle of the BTE unit and the threshold range, the target length of the SDS, etc.) and cause a display device to display the information to an HCP.

The principles described herein may result in improved fitting techniques for a hearing device as compared to conventional fitting techniques that do not include a communication means configured to indicate when the pitch angle of the BTE unit is within the threshold range. For example, such communication means may allow the hearing device to be fitted to an end user more efficiently and/or accurately by indicating when the pitch angle of the BTE unit is within the threshold range and/or a target length of the SDS based on the pitch angle of the BTE unit being within the threshold range. Moreover, the fitting techniques described herein may provide a more reliable selection of a sufficient length for the SDS for various users and/or types of hearing devices, which may properly position the BTE unit behind the ear of the user and thereby increase performance of the hearing device (e.g., microphones included in the BTE unit may be properly positioned to sufficiently detect sound and/or perform beamformer techniques).

Various embodiments will now be described in more detail with reference to the figures. The systems, hearing devices, and methods described herein may provide one or more of the benefits mentioned above and/or various additional and/or alternative benefits that will be made apparent herein.

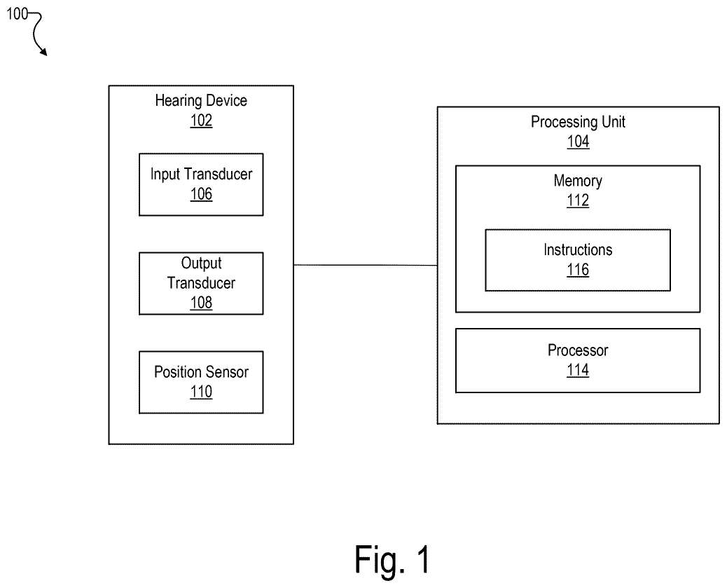

FIG. 1 shows an illustrative implementation 100 of a hearing system that may be fitted to an end user. As shown, implementation 100 includes a hearing device 102 communicatively coupled with a processing unit 104. Implementation 100 may include additional or alternative components as may serve a particular implementation.

Hearing device 102 may be implemented by any type of hearing device configured to enable or enhance hearing by an end user wearing hearing device 102. For example, hearing device 102 may be implemented by a hearing aid configured to provide an amplified version of audio content to an end user, a sound processor included in a bimodal hearing system configured to provide both amplification and electrical stimulation representative of audio content to an end user, or any other suitable hearing prosthesis.

As shown, hearing device 102 includes one or more input transducers 106, one or more output transducers 108, and one or more position sensors 110. Hearing device 102 may include additional or alternative components as may serve a particular implementation.

Input transducer 106 may be implemented by one or more suitable audio detection devices (e.g., one or more microphones) configured to detect an audio signal presented to an end user of hearing device 102. The audio signal may include, for example, audio content (e.g., music, speech, noise, etc.) generated by one or more audio sources as present in an environment of the user. Input transducer 106 may be included in or communicatively coupled to hearing device 102 in any suitable manner. Output transducer 108 may be implemented by any suitable audio output device, for instance a loudspeaker, also called a “receiver,” of a hearing device.

Position sensor 110 may be implemented by any suitable sensor configured to detect an orientation of hearing device 102 and output position data representative of the orientation of hearing device 102 such as an angle relative to the gravity direction. For example, position sensor 110 may include any suitable inertial sensor (e.g., an inertial measurement unit (IMU), an accelerometer, etc.). Position sensor 110 includes a gravity direction detector sensitive to the earth's gravitation field so that the gravity direction detector is configured to detect a gravity direction of the earth's gravitation field, which may be used to derive the orientation of position sensor 110 and/or hearing device 102 with regard to the gravity direction. Accordingly, while hearing device 102 is being worn by an end user, the position data output by position sensor 110 of hearing device 102 may be representative of the orientation of hearing device 102.

Processing unit 104 may be implemented by one or more computing devices and/or computer resources (e.g., processors, memory devices, storage devices, etc.) as may serve a particular implementation. For example, processing unit 104 may be implemented by a mobile device, personal computer, and/or other computing device configured to be communicatively coupled (e.g., by way of a wired and/or wireless connection) to hearing device 102. As shown, processing unit 104 may include, without limitation, a memory 112 and a processor 114 selectively and communicatively coupled to one another. Memory 112 and processor 114 may each include or be implemented by computer hardware that is configured to store and/or process computer software. Various other components of computer hardware and/or software not explicitly shown in FIG. 1 may also be included within processing unit 104. In some examples, memory 112 and/or processor 114 may be distributed between multiple devices and/or multiple locations as may serve a particular implementation.

Memory 112 may store and/or otherwise maintain executable data used by processor 114 to perform any of the functionality described herein. For example, memory 112 may store instructions 116 that may be executed by processor 114. Memory 112 may be implemented by one or more memory or storage devices, including any memory or storage devices described herein, that are configured to store data in a transitory or non-transitory manner. Instructions 116 may be executed by processor 114 to cause processing unit 104 to perform any of the functionality described herein. Instructions 116 may be implemented by any suitable application, software, code, and/or other executable data instance. Additionally, memory 112 may also maintain any other data accessed, managed, used, and/or transmitted by processor 114 in a particular implementation.

Processor 114 may be implemented by one or more computer processing devices, including general purpose processors (e.g., central processing units (CPUs), graphics processing units (GPUs), microprocessors, etc.), special purpose processors (e.g., application specific integrated circuits (ASICs), field-programmable gate arrays (FPGAs), etc.), image signal processors, or the like. Using processor 114 (e.g., when processor 114 is directed to perform operations represented by instructions 116 stored in memory 112), processing unit 104 may perform various operations as described herein.

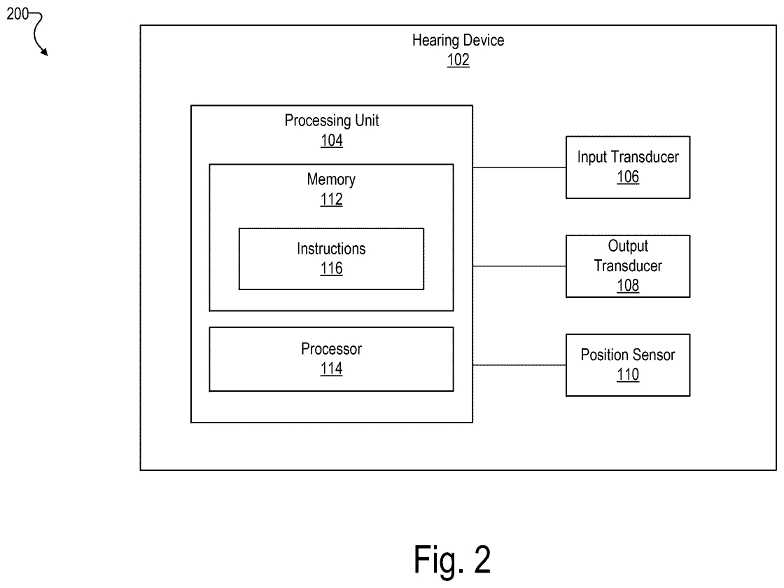

FIG. 2 shows another illustrative implementation 200 of a hearing system that may be fitted to an end user. As shown, implementation 200 is similar to implementation 100, except that implementation 200 includes processing unit 104 located within hearing device 102. Implementation 200 may include additional or alternative components as may serve a particular implementation.

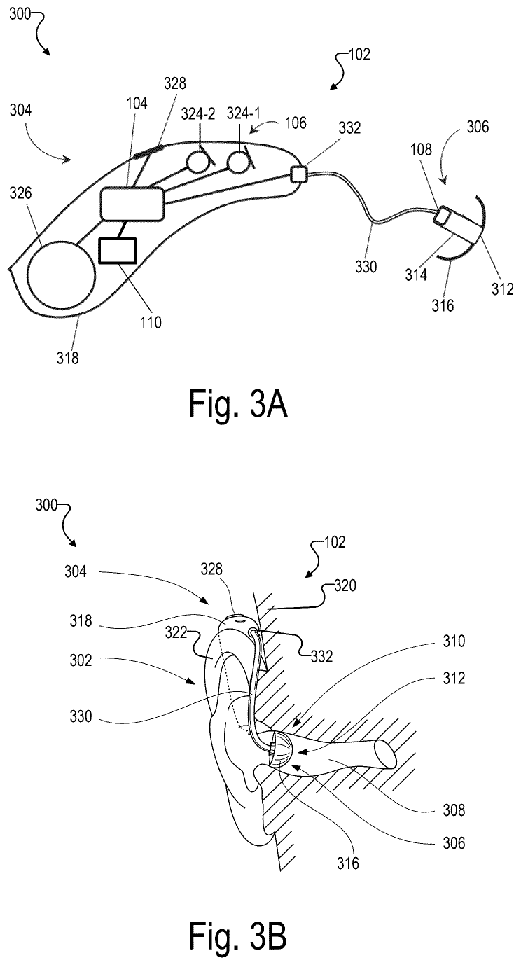

FIGS. 3A and 3B show another illustrative implementation 300 of hearing device 102 implemented as an RIC hearing device. For example, FIG. 3A shows a schematic of implementation 300 and FIG. 3B shows implementation 300 being worn at an ear 302 of an end user.

As shown, implementation 300 comprises a BTE unit 304 adapted to be worn at ear 302 of an end user at a wearing position behind the ear, and an earpiece 306 adapted to be worn at ear 302 of the end user at a wearing position at least partially inside an ear canal 308 (e.g., at an entrance 310 of ear canal 308) of ear 302. As shown, earpiece 306 comprises a housing 312 at least partially insertable in ear canal 308. Housing 312 comprises an enclosure 314 accommodating output transducer 108. Housing 312 further comprises a flexible member 316 adapted to contact a wall of ear canal 308 when housing 312 is at least partially inserted into ear canal 308. In this way, an acoustical seal with the ear canal wall may be provided at the housing portion contacting the ear canal wall. In the illustrated example, flexible member 316 is formed as a tip or a dome typically made from a soft elastic material to allow for comfortable accommodation of earpiece 306 in ear canal 308 to secure seat of earpiece 306 in ear canal 308. Alternatively, earpiece 306 may be formed by an earmold (e.g., mold shapes that are custom fit to ear 302 and/or ear canal 308 of the respective user).

BTE unit 304 comprises an additional housing 318 for wearing behind ear 302. Housing 318 has a slightly curved anatomic outer shape so as to be comfortably worn behind ear 302. For example, BTE unit is typically retained behind ear 302 in such a manner that a large part of the BTE unit 304 is located between a skull 320 and an ear pinna 322 of the end user. Housing 318 accommodates processing unit 104 communicatively coupled to input transducer 106 and position sensor 110 included in BTE unit 304. In the illustrated example, input transducer 106 includes a first microphone 324-1 and a second microphone 324-2 spaced away from first microphone 324-1. BTE unit 304 further includes a battery 326 as a power source and a visual indicator 328 configured to emit light. For example, visual indicator 328 may be implemented by one or more light emitting diodes (LEDs) configured to emit one or more types (e.g., green, red, orange, yellow, white, etc.) of light.

BTE unit 304 and earpiece 306 are interconnected by a sound delivery system (SDS) 330. In the illustrated example, SDS 330 is implemented as a cable having one end connected to earpiece 306 and an opposite end connected to BTE unit 304 by a connection 332. For example, connection 332 may be formed by a plug-and-socket connection configured to functionally connect BTE unit 304 with SDS 330 (e.g., to communicatively couple processing unit 104 to output transducer 108 via the cable of SDS 330). Processing unit 104 is thus configured to access an audio signal generated by input transducer 106, to process the audio signal, and to provide the processed audio signal to output transducer 108. Connection 332 may further be configured as a releasable coupling to releasable couple BTE unit 304 with SDS 330.

While the illustrated example shows output transducer 108 included in earpiece 306, output transducer 108 may additionally or alternatively be included in BTE unit 304. In instances where output transducer 108 is included in BTE unit 304, SDS 330 may be implemented as a tubular sound channel configured to guide sound waves output by output transducer 108 in BTE unit 304 to earpiece 306.

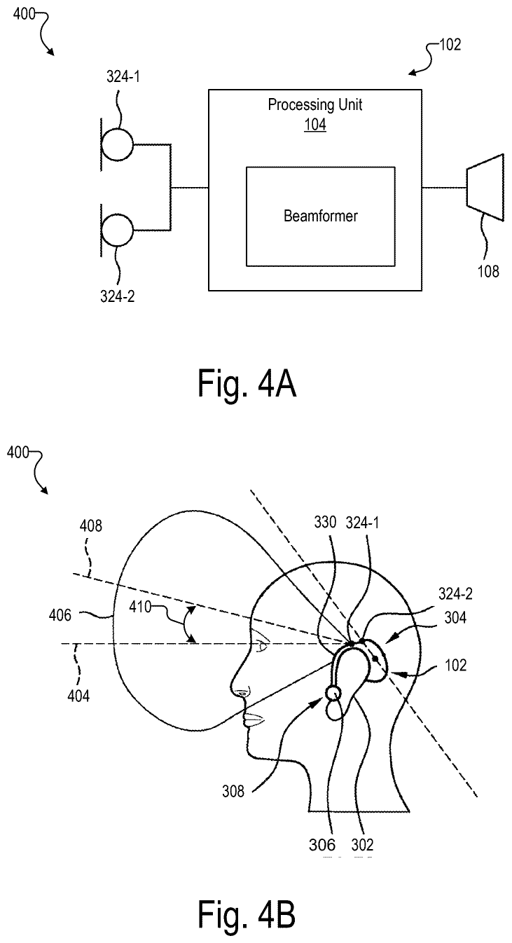

FIGS. 4A and 4B show another illustrative implementation 400 of hearing device 102 that includes a beamformer functionality. For example, FIG. 4A shows a schematic of implementation 400 and FIG. 4B shows implementation 400 being worn at an ear 302 of an end user.

As shown, implementation 400 includes a beamformer, which receives sound signals from microphones 324 (e.g., first microphone 324-1 and second microphone 324-2). Based on receiving an audio signal from each microphone 324, the beamformer may amplify sound from a specific direction and/or attenuate sound from other directions. To illustrate, the beamformer may be configured to amplify sound in a viewing direction 404 of the user and attenuate sound from other directions, as indicated by amplification curve 406. The beamformer may further be configured to output a beamformed sound signal, such as to processing unit 104, which may amplify the beamformed sound signal and provide the amplified beamformed sound signal to output transducer 108. The beamformer functionality is implemented in whole or in part by processing unit 104.

As mentioned before, the pitch angle 410 is the angle between the microphone axis/beamformer direction 408 and the viewing direction of the hearing-impaired end user, i.e., a horizontal plane 404 that is oriented substantially perpendicularly relative to the gravity direction of the earth's gravitational field. The beamformer has a beamformer direction 408, in which the orientation to a speaker or a sound source the end user is looking at is maximal. In a first hypothesis, beamformer direction 408 of the beamformer is substantially parallel to viewing direction 404 and/or a horizontal plane that is oriented substantially perpendicularly relative to the gravity direction of the earth's gravitational field. The pitch angle 410 is also known as a “tilt angle” of BTE unit 304 since the positions of microphones 324 within BTE unit 304 depend on pitch angle 410. For example, pitch angle 410 may represent an orientation and/or rotation of BTE unit 304 (e.g., a microphone axis/beamformer direction 408 of BTE unit 304 extending through microphones 324 of BTE unit 304) about a pitch axis running transversely through the head of the user (e.g., from ear to ear).

Accordingly, the position of BTE unit 304 at ear 302 of the user influences the performance of the beamformer. For example, when BTE unit 304 is properly positioned at ear 302 to align beamformer direction 408 with viewing direction 404 and/or the horizontal plane (e.g., BTE unit 304 is oriented to have a pitch angle 410 between about −5 degrees and about +15 degrees relative to viewing direction 404 and/or the horizontal plane) to a large degree, performance of the beamformer may be enhanced. Alternatively, when BTE unit 304 is improperly positioned at ear 302 such that beamformer direction 408 is misaligned with viewing direction 404 and/or the horizontal plane (e.g., BTE unit 304 is oriented to have a pitch angle 410 less than about −5 degrees or more than about +15 degrees relative to viewing direction 404 and/or the horizontal plane), performance of the beamformer may be decreased. As an illustrative example, a misalignment of pitch angle 410, such as by about 10° outside the threshold range, may result in a deterioration of a directivity index (DI) of hearing device 102 by about 0.5 decibels (dB) to about 1 dB and/or about 10% loss of speech understanding.

Pitch angle 410 of BTE unit 304 may vary between respective users. For example, pitch angle 410 may depend on one or more factors, such as one or more of the anatomy of the user's ear, the shape of BTE unit 304, the arrangement of microphones 324 within BTE unit 304, the length of SDS 330, whether the user wears glasses that may interfere with the position of BTE unit 304, aesthetic preferences, etc. As an illustrative example, pitch angle 410 may depend on the length of SDS 330 interconnecting BTE unit 304 with earpiece 306 (e.g., too short or too long SDS lengths may lead to a deviation of pitch angle 410 from a desired range).

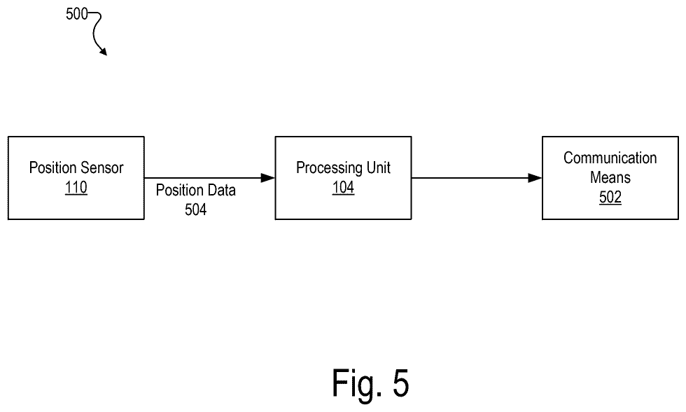

FIG. 5 shows an illustrative implementation 500 of a fitting system for fitting hearing device 102 to an end user based on a pitch angle 410 of BTE unit 304. As shown, fitting system 500 includes position sensor 110 (e.g., included in BTE unit 304), processing unit 104, and a communication means 502. Fitting system 500 may include additional or alternative components as may serve a particular implementation.

As shown, position sensor 110 is configured to provide position data 504 representative of the orientation of BTE unit 304 relative to an ear (e.g., ear 302) of the end user. In some examples, position data 504 may include data representative of an orientation of position sensor 110 and/or BTE unit 304 relative to the gravity direction. In some examples, position data 504 may be generated and/or provided by position sensor 110 upon request, such as based on user input designated by a user such as an HCP (e.g., an HCP may interact with a user interface communicatively coupled with processing unit 104 to provide user input representative of a request to generate and/or provide position data 504). Additionally or alternatively, position data 504 may be updated continuously and/or periodically (e.g., every second, every 5 seconds, every 10 seconds, every 30 seconds, every minute, etc.) such as to indicate changes in the orientation of position sensor 110 and/or BTE unit 304 (e.g., based on motion of BTE unit 304 relative to the gravity direction).

Based on position data 504, processing unit 104 may be configured to determine when pitch angle 410 of BTE unit 304 is within a threshold range (e.g., a pitch angle 410 between about −5 degrees and about +15 degrees relative to viewing direction 404 and/or the horizontal plane). The pitch angle value in the middle of that threshold range would be +5 degrees. This would be optimal for a major share of hearing device users because many people's bodies are slightly bent forward when they walk around. Moreover, there is a large share of end users wearing hearing devices that are elderly people. Elderly people are often a bit shorter in length compared to younger people. Hence, the angle of +5 degrees would perfectly point slightly upwards and thus address that likely body height difference. However, the perfect pitch angle is subject to personal preferences of the end user and may thus not be exactly +5 degrees. In some examples, processing unit 104 is configured to determine pitch angle 410, such as by deriving pitch angle 410 from the orientation of position sensor 110 and/or BTE unit 304 relative to the gravity direction. As an illustrative example, one or more parameters (e.g., the arrangement of microphones 324, beamformer direction 408, the arrangement of position sensor 110 relative to microphones 324, etc.) of BTE unit 304 may be known (e.g., based on the type of BTE unit 304) such that pitch angle 410 may be derived based on the one or more known parameters with respect to the orientation of position sensor 110 and/or BTE unit 304 relative to the gravity direction.

In instances where position data 504 is updated, processing unit 104 may further be configured to update pitch angle 410, such as instantaneously based on the changes in position data 504 and/or over a period of time, such as when the end user wears BTE unit 304 for the period of time. For example, processing unit 104 may be configured to determine pitch angle 410 based on one or more statistics (e.g., a median, a mean, etc.) of pitch angle 410 over the period of time. In such instances where pitch angle 410 is updated, processing unit 104 may further determine whether the updated pitch angle 410 is within the threshold range.

As will be discussed in more detail below, communication means 502 may be configured to indicate when pitch angle 410 of BTE unit 304 is within the threshold range for determining the target length of SDS 330. To illustrate, communication means 502 may provide a notification, such as to an HCP, when pitch angle 410 is within the threshold range. Such a notification may include a visual, textual, and/or audio alert provided by hearing device 102 and/or another component connected to hearing device 102 as will be described in more detail below. Additionally or alternatively, communication means 502 and/or processing unit 104 may be configured to categorize pitch angle 410 of BTE unit 304. As an illustrative example, pitch angle 410 may be categorized as optimal (e.g., when pitch angle 410 is optimally within the threshold range, which may result in optimal hearing and/or beamformer performance by hearing device 102), suboptimal (e.g., when pitch angle 410 is suboptimally within the threshold range, which may result in limited hearing and/or beamformer performance by hearing device 102), and/or unsatisfactory (e.g., when pitch angle 410 is outside the threshold range, which may result in severely restricted hearing and/or beamformer performance by hearing device 102). In instances where pitch angle 410 is categorized, the notification provided by communication means 502 may be based on the categorization. Still other configurations for notifying and/or categorizing pitch angle 410 may be used.

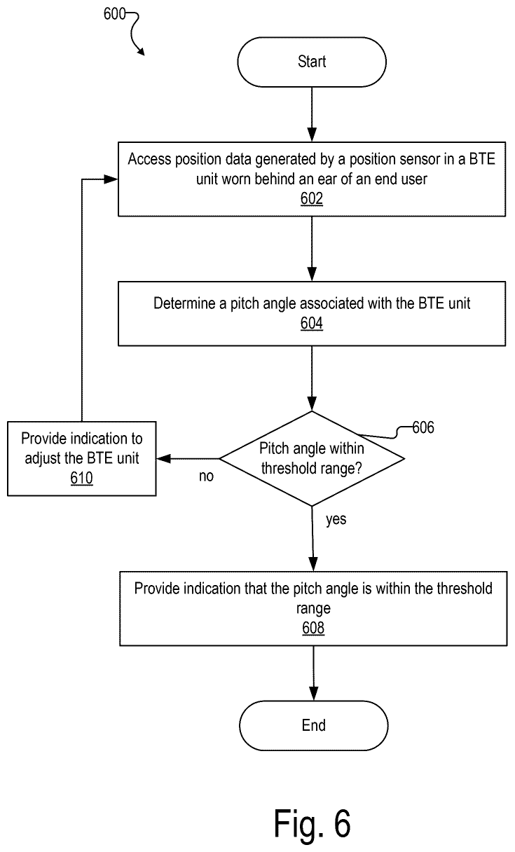

FIG. 6 shows an illustrative method 600 that may be performed by a fitting system (e.g., fitting system 500) for indicating a target length of an SDS (e.g., SDS 330) for a hearing device (e.g., hearing device 102), the SDS configured to connect a BTE unit (e.g., BTE unit 304) positioned behind the ear of an end user with an earpiece (e.g., earpiece 306) when worn by the end user. While FIG. 6 illustrates exemplary operations according to one embodiment, other embodiments may omit, add to, reorder, and/or modify any of the operations shown in FIG. 6. Moreover, each of the operations depicted in FIG. 6 may be performed in any of the ways described herein. Method 600 may be implemented by one or more components of fitting system 500 (e.g., processing unit 104) and/or hearing system 100.

As shown, method 600 includes, at operation 602, accessing position data (e.g., position data 504) generated by a position sensor (e.g., position sensor 110) in the BTE unit worn behind the ear of the end user. The position data is representative of an orientation of the BTE unit relative to the gravity direction. For example, the position data may be based on an orientation of position sensor 110 relative to the gravity direction detected by a gravity direction detector of position sensor 110.

Method 600 further includes, at operation 604, determining a pitch angle (e.g., pitch angle 410) associated with the BTE unit. To illustrate, the pitch angle may be derived from the position data such as by determining an orientation of the BTE unit relative to a horizontal plane oriented substantially perpendicularly to the gravity direction. In some examples, the pitch angle is further determined based on one or more known parameters associated with the BTE unit (e.g., the arrangement of microphones 324, beamformer direction 408, the arrangement of position sensor 110 relative to microphones 324, etc.).

For example, position sensor 110 may be mounted offset from an axis extending through microphones 324 in BTE unit 304. Accordingly, pitch angle 410 may be derived based on the offset of position sensor 110 from the microphone axis relative to the gravity direction. To illustrate, position sensor 110 may be mounted in BTE unit 304 at an angle of about 35° relative to the microphone axis. If an angle of about 23° relative to the gravity direction is measured by position sensor 110, then an offset of about 35° may be applied to determine a pitch angle 410 of about 32° (e.g., pitch angle=90°-(23°+35°)) relative to the horizontal plane.

Method 600 further includes, at operation 606, determining whether the pitch angle of the BTE unit is within a threshold range. For example, determining whether the pitch angle is within the threshold range may include comparing the determined pitch angle to a target range of angles (e.g., between about −5 degrees and about +15 degrees relative to the horizontal plane) associated with the BTE unit in which the BTE unit is properly positioned to provide sufficient performance of the hearing device. When the pitch angle is within the threshold range (e.g., yes, at operation 606), method 600 includes, at operation 608, providing an indication (e.g., a notification), such as to an HCP, that the pitch angle is within the threshold range. Alternatively, when the pitch angle is outside the threshold range (e.g., no, at operation 606), method 600 includes, at operation 610, providing an indication (e.g., a notification), such as to the HCP, to adjust the BTE unit. For example, based on the indication, the HCP may adjust the orientation of the BTE unit relative to the ear of the end user. Method 600 may be repeated, such as until the pitch angle of the BTE unit is within the threshold range. Method 600 may further be repeated on another ear of the end user to fit another hearing device to the other ear such as in instances where the end user is being fitted with a binaural hearing device.

In some examples, method 600 may further include indicating a target length for the SDS such as a length of the SDS that maintains the position the BTE to have a pitch angle within the threshold range. In some examples, the indicated target length is provided as one or more target lengths each associated with a different type of SDS 330 and/or earpiece 306. To illustrate, one target length may be provided for an SDS 330 implemented as a cable and another target length may be provided for an SDS 330 implemented as a tubular sound channel. Additionally or alternatively, one target length may be provided for an SDS 330 connecting BTE unit 304 with a dome-type earpiece 306 and another target length may be provided for an SDS 330 connecting BTE unit 304 with a custom earpiece 306.

Additionally or alternatively, the HCP may select the length of the SDS based on the indication of the target length. To illustrate, the HCP may select an SDS having the target length from a set of pre-manufactured SDSs having different lengths, such as in instances where an earpiece (e.g., earpiece 306) of the hearing device is a standard earpiece (e.g., a dome) and/or a custom earpiece having a standard core. Alternatively, the HCP may select an SDS to order (e.g., from a hearing device manufacturer) having the target length, such as in instances where the earpiece is a custom earpiece having a non-standard core. In some examples, the HCP may adjust the target length of the SDS indicated by the fitting system, such as to accommodate preferences of the end user (e.g., the HCP may evaluate both pitch angle 410 and visual appearance, such as front and/or side visibility, of BTE unit 304 and select the target length of the SDS based on a compromise between pitch angle 410 and the visibility). For example, an end user that wears glasses and/or has non-protruding ears may need a longer SDS 330.

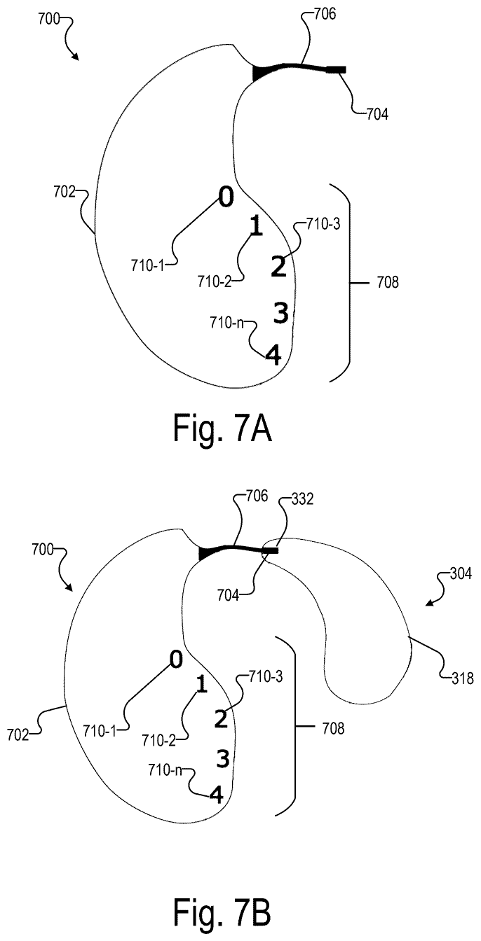

In some examples, communication means 502 may comprise a visual indicator device releasably coupled with the BTE unit. For example, FIGS. 7A and 7B show schematics of an illustrative implementation 700 of a visual indicator device that may be releasably coupled with BTE unit 304. As shown, visual indicator device 700 includes a body 702 and a connector portion 704 coupled by a support member 706. Visual indicator device 700 may include additional or alternative components as may serve a particular implementation.

Body 702 depicts a scale 708 having a plurality of increments 710 (e.g., increments 710-1 through 710-n) aligned along scale 708 (e.g., in a vertical direction oriented substantially parallel with the gravity direction). In some examples, increments 710 are spaced about 3 millimeters (mm) to about 5 mm apart from each other, though any suitable spacing may be used. Each increment included in the plurality of increments 710 represents a specific SDS length. Each increment 710 may be depicted as any suitable metric (e.g., an integer, a distance, a length, etc.) representative of a specific SDS length. In some examples, an increment 710 having a higher value within a given range (e.g., 0 to 4) may indicate a longer target length of SDS 330, while an increment 710 having a lower value within the given range may indicate a shorter target length of SDS 330. To illustrate, FIGS. 7A and 7B show a second increment 710-2 (e.g., “1”) spaced a distance below (e.g., farther away from BTE unit 304) a first increment 710-1 (e.g., “0”) such that second increment 710-2 represents a longer length of SDS 330 than first increment 710-1, a third increment 710-3 (e.g., “2”) is spaced a distance below second increment 710-2 such that third increment 710-3 represents a longer length of SDS 330 than second increment 710-2, and so on. Still other configurations for increments 710 may be used.

Body 702 is adapted to be positioned at the ear of the end user (e.g., in front of and/or over the ear pinna). In some examples, body 702 is shaped to extend along an ear pinna of the ear such as to align scale 708 at an ear canal entrance and/or any other feature of the ear useful for determining the target length of SDS 330. Body 702 may be formed from a rigid material (e.g., plastic) such that the shape of body 702 and/or the spacing between increments 710 is fixed.

Connector portion 704 is adapted to connect visual indicator device 700 with connection 332 of BTE unit 304. For example, connector portion 704 and connection 332 each form part of a releasable coupling configured to releasably couple visual indicator device 700 with BTE unit 304. When BTE unit 304 is decoupled from an SDS 330, connector portion 704 of visual indicator device 700 may be connected with connection 332 of BTE unit 304 to releasably couple visual indicator device 700 with BTE unit 304. In some examples, the releasable coupling defines a coupling axis such that the releasable coupling is configured to allow visual indicator device 700 to rotate about the coupling axis relative to housing 318 of BTE unit 304. For example, visual indicator device 700 may be rotated outward (e.g., away from a skull of the end user) and/or inward (e.g., toward a skull of the end user) such as to accommodate a respective end user's anatomy.

Alternatively, when BTE unit 304 is decoupled from visual indicator device 700, an end of SDS 330 may be connected with connection 332 of BTE unit 304 to functionally couple SDS 330 with BTE unit 304. To illustrate, when SDS 330 is implemented as a cable, an electric plug attached to one end of the cable may form a part of the releasable coupling and/or when SDS 330 is implemented as a tubular sound channel, a connector portion attached to one end of the tubular sound channel may form a part of the releasable coupling. Still other configurations for the releasable coupling may be used to releasably couple BTE unit 304 with visual indicator device 700 and/or SDS 330.

Support member 706 of visual indicator device 700 extends between body 702 and connector portion 704 to couple body 702 with connector portion 704. Support member 706 is adapted to extend over an ear (e.g., the ear pinna) of the end user when BTE unit 304 is positioned behind the ear such that support member 706 may position body 702 of visual indicator device 700 in front of and/or over the ear. A length of support member 706 may be fixed so as to maintain a distance between BTE unit 304 and body 702 (e.g., increments 710) when visual indicator device 700 is coupled with BTE unit 304. In some examples, support member 706 may be formed a rigid material (e.g., plastic) such as to maintain the position of body 702 relative to housing 318 of BTE unit 304. Still other configurations for support member 706 may be used. For example, support member 706 may additionally or alternatively be formed from a semi-flexible material such as to allow support member 706 to adapt to the shape of the ear of the end user when visual indicator device 700 and BTE unit 304 are worn by the end user (e.g., while maintaining the distance between BTE unit 304 and increments 710). In some instances, visual indicator device 700 may be injection molded (e.g., support member 706 may be integral with body 702).

When visual indicator device 700 is coupled with BTE unit 304, BTE unit 304 and visual indicator device 700 are configured to be rotated together to adjust the orientation of BTE unit 304 and visual indicator device 700 relative to the ear of the end user (e.g., to position pitch angle 410 of BTE unit 304 within the threshold range). For example, BTE unit 304 and visual indicator device 700 may be simultaneously rotated about the pitch axis running transversely through the head of the end user (e.g., from ear to ear). Accordingly, when the pitch angle of BTE unit 304 is within the threshold range, visual indicator device 700 may indicate the target length of SDS 330 via increments 710 on scale 708.

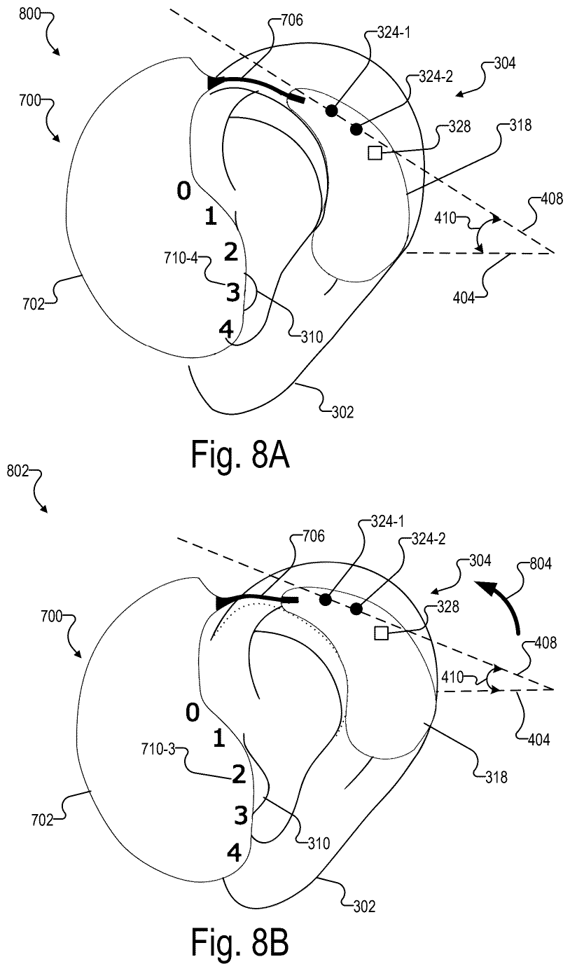

As an illustrative example, FIG. 8A shows an implementation 800 in which visual indicator device 700 is coupled with BTE unit 304 and positioned at ear 302 of the end user. As shown, BTE unit 304 is positioned behind ear 302 and support member 706 of visual indicator device 700 extends over ear 302 to position body 702 of visual indicator device 700 in front of ear 302. In this position, one or more increments 710 of scale 708 depicted on body 702 are aligned with a particular feature of ear 302, such as entrance 310 of ear canal 308. In the illustrated example, a fourth increment 710-4 (e.g., “3”) of visual indicator device 700 is substantially aligned with the particular feature (e.g., entrance 310 of ear canal 308). However, BTE unit 304 is positioned too far behind ear 302 such that pitch angle 410 of BTE unit 304 is outside the threshold range (e.g., pitch angle 410 is greater than 15 degrees to the horizontal plane and/or viewing direction 404). Accordingly, the SDS length associated with the fourth increment 710-4 may be too long, which may result in BTE unit 304 being improperly positioned for insufficient performance of hearing device 102.

FIG. 8B shows another illustrative implementation 802 in which BTE unit 304 and visual indicator device 700 have been simultaneously rotated (e.g., counterclockwise) about the pitch axis (e.g., as indicated by arrow 804) to orient BTE unit 304 farther forward on ear 302. Such rotation of BTE unit 304 and visual indicator device 700 may orient BTE unit 304 to decrease pitch angle 410 of BTE unit 304 to be within the threshold range. In this position, a third increment 710-3 (e.g., “2”) of visual indicator device 700 is substantially aligned with the particular feature of ear 302 (e.g., entrance 310 of ear canal 308). Because BTE unit 304 is oriented behind ear 302 such that pitch angle 410 of BTE unit 304 is within the threshold range (e.g., pitch angle 410 is less than 15 degrees to the horizontal plane and/or viewing direction 404), the SDS length associated with the third increment 710-3 may represent the target length of an SDS 330 that may result in BTE unit 304 being properly positioned for sufficient performance of hearing device 102.

In some examples, visual indicator 328 included in BTE unit 304 is configured to provide a visual indication when pitch angle 410 of BTE unit 304 is within the threshold range. For example, visual indicator 328 may be implemented as one or more LEDs configured to emit a first light when BTE unit 304 is positioned relative to the ear such that pitch angle 410 of BTE unit 304 is within the threshold range. The one or more LEDs may further be configured to emit a second light that is different than the first light when BTE unit 304 is positioned relative to the ear such that pitch angle 410 of BTE unit 304 is outside of the threshold range. As an illustrative example, the one or more LEDs may emit a green light when pitch angle 410 is within the threshold range and a red light when pitch angle 410 is outside the threshold range. Accordingly, visual indicator 328 may be configured to provide a notification to the HCP when pitch angle 410 of BTE unit 304 is within the threshold range.

Still other configurations for light emitted by the one or more LEDs to indicate when pitch angle 410 is within the threshold range may be used. To illustrate, the one or more LEDs may be configured to blink and/or emit continuous light when pitch angle 410 is within and/or outside of the threshold range. Additionally or alternatively, the light emitted by the one or more LEDs may indicate a category of pitch angle 410. To illustrate, the one or more LEDs may emit the first light (e.g., a green light) when pitch angle 410 of BTE unit 304 is categorized as optimal (e.g., when pitch angle 410 is optimally within the threshold range, such as pitch angles 410 between about −5° and about +10°), the one or more LEDs may emit the second light (e.g., a yellow or orange light) when pitch angle 410 of BTE unit 304 is categorized as suboptimal (e.g., when pitch angle 410 is suboptimally within the threshold range, such as pitch angles 410 between about +10° and about +15°), and/or the one or more LEDs may emit a third light (e.g., a red light) when pitch angle 410 of BTE unit 304 is categorized as unsatisfactory (e.g., when pitch angle 410 is outside the threshold range, such as pitch angles 410 less than about −5° and greater than about +15°).

When pitch angle 410 of BTE unit 304 is outside the threshold range, visual indicator 328 of BTE unit 304 may indicate that pitch angle 410 is outside the threshold range (e.g., by emitting a light indicative of pitch angle 410 being outside the threshold range), which may notify an HCP fitting hearing device 102 to adjust the orientation of BTE unit 304. Alternatively, when pitch angle 410 of BTE unit 304 is within the threshold range, visual indicator 328 of BTE unit 304 may indicate that pitch angle 410 is within the threshold range (e.g., by emitting a light indicative of pitch angle 410 being within the threshold range), which may notify an HCP fitting hearing device 102 that the orientation of BTE unit 304 is proper for selecting an SDS 330 having a length corresponding to the target length indicated by visual indicator device 700 (e.g., third increment 710-3).

In some instances, the HCP may select an SDS 330 from a set of pre-made SDSs having a length that corresponds to the target length indicated by visual indicator device 700 and/or select an SDS 330 having a length that corresponds to the target length indicated by visual indicator device 700 to be custom made. In some instances, the HCP may select an SDS 330 having a length adjusted (e.g., increased and/or decreased) from the target length such as to accommodate one or more preferences of the end user. Additionally or alternatively, in instances when the particular feature of ear 302 may be positioned between and/or overlap with two increments 710 on scale 708 of visual indicator device 700, the HCP may select an SDS 330 having a length that corresponds to the target length associated with either of the two increments 710, such as based on one or more preferences of the end user.

When the SDS 330 is selected based on the target length indicated by visual indicator device 700, the HCP may decouple visual indicator device 700 from BTE unit 304 at the releasable coupling (e.g., by removing connector portion 704 of visual indicator device 700 from connection 332 of BTE unit 304) and couple the selected SDS 330 having the target length with BTE unit 304 at the releasable coupling (e.g., by coupling an end of SDS 330 with connection 332 of 304). SDS 330 may also be coupled with an earpiece 306 to interconnect BTE unit 304 with earpiece 306, which may be positioned at entrance 310 of ear canal 308. Accordingly, the target length of the selected SDS 330 may maintain the orientation of BTE unit 304 behind ear 302 of the end user such that pitch angle 410 is within the threshold range for sufficient performance of hearing device 102. Accordingly, visual indicator device 700 may reduce or prevent an improper length of SDS 330 from being selected that may result in improper positioning of BTE unit 304 behind ear 302 of the end user.

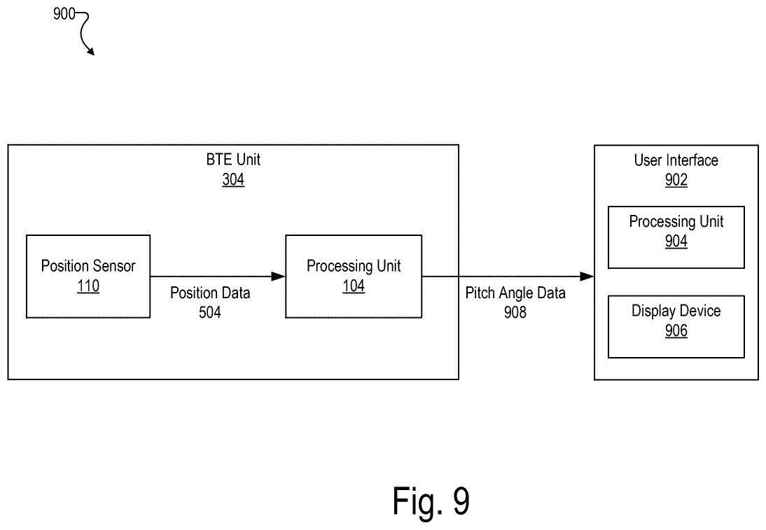

FIG. 9 shows another illustrative implementation 900 of fitting system 500 that includes a user interface 902 as communication means 502. As shown, user interface 902 communicatively coupled with BTE unit 304 (e.g., processing unit 104) and includes a processing unit 904 and a display device 906.

Processing unit 904 may be implemented by one or more computing devices and/or computer resources (e.g., processors, memory devices, storage devices, etc.) as may serve a particular implementation. For example, processing unit 904 may be implemented by a mobile device, personal computer, and/or other computing device configured to be communicatively coupled (e.g., by way of a wired and/or wireless connection) to hearing device 102 (e.g., BTE unit 304).

Processing unit 904 may be configured to access position data 504 and/or pitch angle data 908 from position sensor 110 and/or processing unit 104 of BTE unit 304. Pitch angle data 908 may be representative of pitch angle 410 of BTE unit 304. Based on position data 504 and/or pitch angle data 908, processing unit 904 may further be configured to determine information associated with pitch angle 410 of BTE unit 304, such as one or more of pitch angle 410, the threshold range associated with pitch angle 410, whether pitch angle 410 is within or outside the threshold range, a difference between pitch angle 410 and the threshold range, an orientation of BTE unit 304, a recommendation for adjusting pitch angle 410 of BTE unit 304, the target length of SDS 330, or a specific SDS 330 to select (e.g., from a set of SDSs).

While the illustrated example shows processing unit 904 as a separate component from processing unit 104, processing unit 904 may be implemented in whole or in part by processing unit 104. In instances where processing unit 904 is implemented in whole by processing unit 104, processing unit 104 may be included in either one of user interface 902 or BTE unit 304. Still other configurations for processing unit 904 may be used.

Display device 906 may be implemented by any display device (e.g., a monitor, a watch, a mobile device, etc.) configured to display the information to an HCP. For example, display device 906 may be configured to display the information in a user interface view as will be described in more detail below. Based on the displayed information, the HCP may select an SDS 330 having a target length fit for the end user.

User interface 902 may include additional or alternative components as may serve a particular implementation. For example, user interface 902 may further include a user input device (e.g., a keyboard or keypad, a touchscreen, a microphone, etc.) configured to receive a user input from a user (e.g., an HCP) such as to designate one or more characteristics (e.g., the threshold range for pitch angle 410, the type of BTE unit 304, SDS 330, and/or earpiece 306 included in hearing device 102, etc.) for fitting hearing device 102.

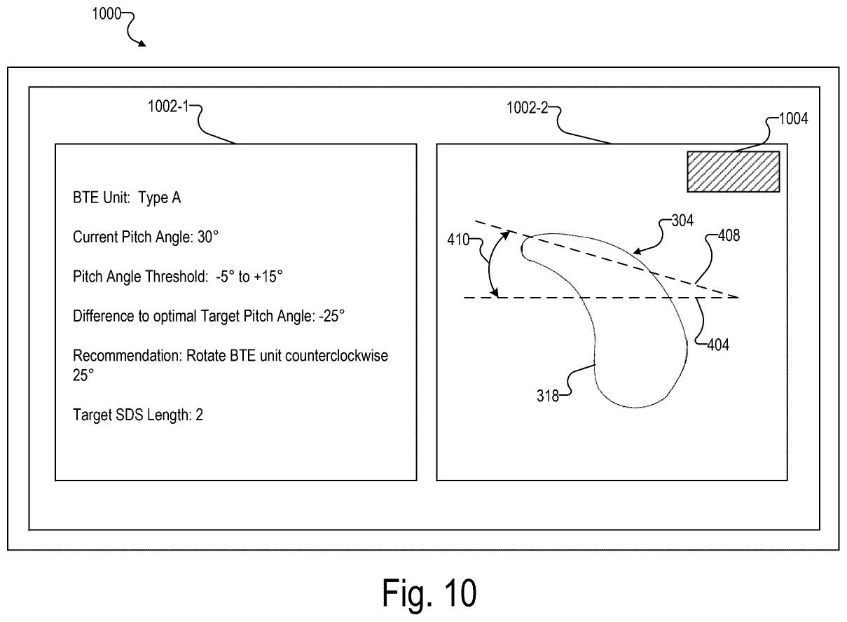

As an illustrative example, FIG. 10 shows a user interface view 1000 that may be displayed by display device 906 of user interface 902 for providing information to the HCP. As shown, user interface view 1000 includes a first display 1002-1 configured to display information, such as a type of BTE unit 304 (e.g., “Type A”), the current pitch angle 410 of BTE unit 304 in its current orientation (e.g., “30°”), the pitch angle threshold (e.g., “−5° to +15°”), a difference between the current pitch angle to the optimal pitch angle threshold (e.g., “−25°), a recommendation for adjustment of pitch angle 410 of BTE unit 304 (e.g., “Rotate BTE unit counterclockwise 25°), or a target SDS length (e.g., “2”).

In the illustrative example, pitch angle 410 of BTE unit 304 is outside the threshold range such that the recommendation includes rotating BTE unit 304 counterclockwise (e.g., forward) an amount to orient pitch angle 410 of BTE unit 304 within the threshold range. This may position pitch angle 410 of BTE unit 304 within the threshold range such that the target length for SDS 330 may be determined. Still other suitable recommendations may be provided. For example, the recommendation may include rotating BTE unit 304 further within the threshold range such that there may be some tolerance associated with pitch angle 410 of BTE unit 304 within the threshold range.

User interface view 1000 further presents a second display 1002-2 configured to display an image representative of a current orientation of BTE unit 304 (e.g., about the pitch axis relative to the horizontal plane and/or viewing direction 404 of the end user). The image may further include one or more visual overlays overlaid on the image such as to indicate the current pitch angle 410 of BTE unit 304, a desired pitch angle 410 of BTE unit 304 within the threshold range, the horizontal plane, a desired orientation of housing 318 of BTE unit 304, etc.

Second display 1002-2 further includes an icon 1004 configured to provide a notification when pitch angle 410 of BTE unit 304 is within the threshold range. For example, icon 1004 may display a first characteristic (e.g., a color, a pattern, a shape, etc.) when BTE unit 304 is positioned relative to the ear such that pitch angle 410 of BTE unit 304 is within the threshold range. Icon 1004 may further display a second characteristic that is different than the first characteristic when BTE unit 304 is positioned relative to the ear such that pitch angle 410 of BTE unit 304 is outside of the threshold range. As an illustrative example, icon 1004 may be displayed as green when pitch angle 410 is within the threshold range and/or as red when pitch angle 410 is outside the threshold range. Icon 1004 may further be configured to indicate a category (e.g., optimal, suboptimal, and/or unsatisfactory) associated with pitch angle 410. Still other suitable configurations for user interface view 1000 may be used.

In some examples, user interface 902 may be configured to update user interface view 1000 such as based on changes associated with the orientation of BTE unit 304. For example, user interface 902 may be configured to continue accessing position data 504 and/or pitch angle data 908 such as to update the information included in first display 1002-1 and/or second display 1002-2. To illustrate, pitch angle 410 of BTE unit 304 may change as the orientation of BTE unit 304 is adjusted by the HCP. User interface view 1000 may be updated to show the change associated with pitch angle 410.

As an illustrative example, the HCP may couple an SDS 330 having a first length (e.g., such as an SDS having a length that fits many end users) with BTE unit 304 and position the coupled SDS 330 and BTE unit 304 on the ear of the end user. User interface 902 may be configured to determine information associated with pitch angle 410 of BTE unit 304 with the coupled SDS 330 and display the information to the HCP. If the information indicates that pitch angle 410 is within the threshold range with the coupled SDS 330, user interface 902 may indicate that the length of the coupled SDS 330 is the target length. Accordingly, the HCP may select the coupled SDS 330 and/or another SDS 330 having a length corresponding to the coupled SDS 330 for hearing device 102 fitted to the end user.

Alternatively, if the information indicates that pitch angle 410 is outside the threshold range with the coupled SDS 330, user interface 902 may indicate that pitch angle 410 is outside the threshold range and/or a target length for SDS 330 based on the amount that pitch angle 410 is outside the threshold range. In some instances where user interface 902 indicates the target length for SDS 330, the HCP may select an SDS 330 having a length that corresponds to the indicated target length. Alternatively, the HCP may decouple the coupled SDS 330 with BTE unit 304 and recouple an additional SDS 330 with BTE unit 304 having a second length that is increased and/or decreased from the first length based on the information provided by user interface 902. User interface 902 may update the information based on the orientation of BTE unit 304 with the additional SDS 330. This process may be repeated until pitch angle 410 of BTE unit 304 is within the threshold range to indicate the target length of SDS 330 for the end user.

In some examples, processing unit 104 and/or processing unit 904 is configured to operate BTE unit 304 in a fitting mode, such as when visual indicator device 700 and/or user interface 902 is coupled with BTE unit 304. While in the fitting mode, BTE unit 304 may be abstained from operating with normal hearing operation (e.g., configured to detect sound). The fitting mode may be designated by the HCP, such as by interacting with user interface 902. Additionally or alternatively, processing unit 104 may be configured to detect when visual indicator device 700 and/or user interface 902 is connected with BTE unit 304 to automatically initiate the fitting mode.

During the fitting mode, the fitting system may be configured to provide instructions and/or a means for the end user to look straight ahead such that the head position is normal (e.g., viewing direction 404 is aligned with the horizontal plane). To illustrate, user interface 902 may display or otherwise provide instructions for the HCP to tell the end user to look at a specific location (e.g., a picture on a wall) at which the end user looks straight ahead and to keep the head as motionless as possible. In some examples, position sensor 110 is configured to detect motion of BTE unit 304 to also monitor if the head is kept sufficiently stable in order to measure pitch angle 410 with a sufficiently low variance (e.g., plus or minus about 5 degrees).

Alternatively, hearing device 102 may be self-fitted by the end user. Accordingly, in the fitting mode, the end user may be instructed, such as by user interface 902, to sit and look straight ahead. User interface 902 may further instruct the end user to couple BTE unit 304 with several different detachable earpieces 306 having different SDS lengths and wear BTE unit 304 behind the ear until an earpiece 306 with an SDS length is found to position pitch angle 410 of BTE unit 304 within the threshold range. For example, user interface 902 may provide a notification to the end user when pitch angle 410 is within the threshold range.

After the SDS length is determined, BTE unit 304 may abstain from operating in the fitting mode and continue normal hearing operation. The end of fitting mode may be designated by the HCP, such as by interacting with user interface 902. Additionally or alternatively, processing unit 104 may be configured to detect when visual indicator device 700 and/or user interface 902 is disconnected with BTE unit 304 to automatically end the fitting mode.

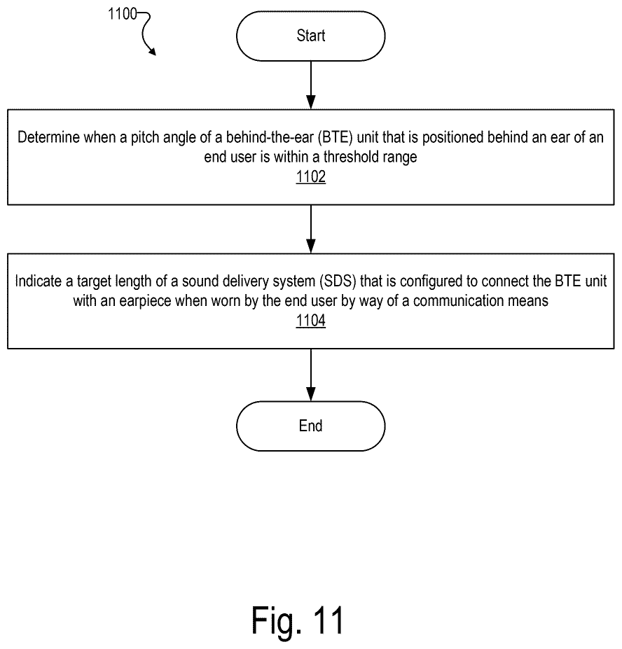

FIG. 11 shows another illustrative method 1100 that may be performed by a fitting system for fitting a hearing device (e.g., hearing device 102) to an end user. While FIG. 11 illustrates exemplary operations according to one embodiment, other embodiments may omit, add to, reorder, and/or modify any of the operations shown in FIG. 11. Moreover, each of the operations depicted in FIG. 11 may be performed in any of the ways described herein. Method 1100 may be implemented by one or more components of fitting system 500 (e.g., processing unit 104), fitting system 900 (e.g., processing unit 904) and/or hearing system 100.

As shown, method 1100 includes, at operation 1102, determining when a pitch angle (e.g., pitch angle 410) of a BTE unit (e.g., BTE unit 304) that is positioned behind an ear of an end user is within a threshold range. For example, the pitch angle of the BTE unit may be determined based on position data (e.g., position data 504) representative of an orientation of the BTE unit relative to the ear of the end user and/or pitch angle data (e.g., pitch angle data 908) representative of the pitch angle. The determined pitch angle may be compared to the threshold range to determine when the pitch angle is within the threshold range.

Method 1100 further includes, at operation 1104, indicating a target length of an SDS (e.g., SDS 330) that is configured to connect the BTE unit with an earpiece (e.g., earpiece 306) when worn by the end user by way of a communication means (e.g., communication means 502, visual indicator device 700, and/or user interface 902). To illustrate, the communication means may include a visual indicator device releasably coupled with the BTE unit. The visual indicator device may depict a scale having a plurality of increments aligned along the scale, each increment representing a specific SDS length. In some examples, the communication means may further include one or more LEDs included in the BTE unit and configured to emit a light when the BTE unit is positioned relative to the ear and relative to the gravity direction such that the pitch angle of the BTE unit is within the threshold range. The communication means may additionally or alternatively include a user interface communicatively coupled to the BTE unit. The user interface may indicate the target length of the SDS such as by displaying information associated with the pitch angle of the BTE unit to a hearing care professional (HCP) within the user interface. For example, the information may include one or more of the pitch angle of the BTE unit, a difference between the pitch angle of the BTE unit and the threshold range, or the target length of the SDS.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”) or static random access memory (“SRAM”), which typically constitutes a main memory. Common forms of computer-readable media include, for example, a disk, hard disk, magnetic tape, any other magnetic medium, a compact disc read-only memory (“CD-ROM”), a digital video disc (“DVD”), any other optical medium, random access memory (“RAM”), programmable read-only memory (“PROM”), electrically erasable programmable read-only memory (“EPROM”), FLASH-EEPROM, any other memory chip or cartridge, or any other tangible medium from which a computer can read.

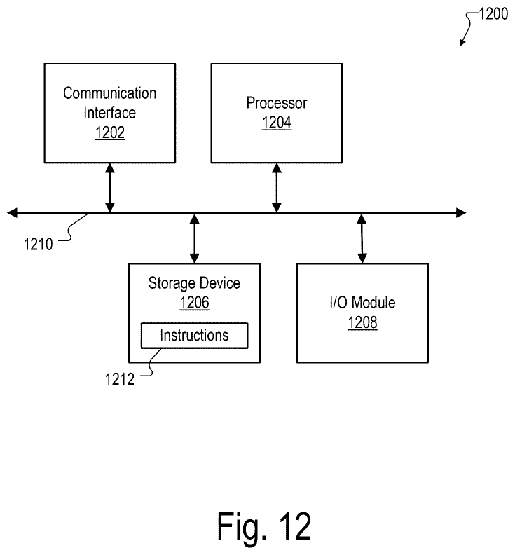

FIG. 12 shows an illustrative computing device 1200 that may be specifically configured to perform one or more of the processes described herein. Any of the systems, computing devices, and/or other components described herein may be implemented by computing device 1200.

As shown in FIG. 12, computing device 1200 may include a communication interface 1202, a processor 1204, a storage device 1206, and an input/output (“I/O”) module 1208 communicatively connected one to another via a communication infrastructure 1210. While an illustrative computing device 1200 is shown in FIG. 12, the components illustrated in FIG. 12 are not intended to be limiting. Additional or alternative components may be used in other embodiments. Components of computing device 1200 shown in FIG. 12 will now be described in additional detail.

Communication interface 1202 may be configured to communicate with one or more computing devices. Examples of communication interface 1202 include, without limitation, a wired network interface (such as a network interface card), a wireless network interface (such as a wireless network interface card), a modem, an audio/video connection, and any other suitable interface.

Processor 1204 generally represents any type or form of processing unit capable of processing data and/or interpreting, executing, and/or directing execution of one or more of the instructions, processes, and/or operations described herein. Processor 1204 may perform operations by executing computer-executable instructions 1212 (e.g., an application, software, code, and/or other executable data instance) stored in storage device 1206.

Storage device 1206 may include one or more data storage media, devices, or configurations and may employ any type, form, and combination of data storage media and/or device. For example, storage device 1206 may include, but is not limited to, any combination of the non-volatile media and/or volatile media described herein. Electronic data, including data described herein, may be temporarily and/or permanently stored in storage device 1206. For example, data representative of computer-executable instructions 1212 configured to direct processor 1204 to perform any of the operations described herein may be stored within storage device 1206. In some examples, data may be arranged in one or more databases residing within storage device 1206.

I/O module 1208 may include one or more I/O modules configured to receive user input and provide user output. I/O module 1208 may include any hardware, firmware, software, or combination thereof supportive of input and output capabilities. For example, I/O module 1208 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1208 is configured to provide graphical data to a display for presentation to a user. The graphical data may be representative of one or more graphical user interfaces and/or any other graphical content as may serve a particular implementation.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A fitting system for determining a target length of a sound delivery system (SDS) from a hearing device, the SDS configured to connect a behind-the-ear (BTE) unit positioned behind an ear of an end user with an earpiece when worn by the end user, the fitting system comprising:
a position sensor included in the BTE unit and having a gravity direction detector configured to generate position data representative of an orientation of the BTE unit relative to a gravity direction;
a processing unit communicatively coupled to the position sensor and configured to determine, based on the position data, when a pitch angle of the BTE unit is within a threshold range; and
a communication means configured to indicate when the pitch angle of the BTE unit is within the threshold range for determining the target length of the SDS.

2. The fitting system of claim 1, wherein the threshold range includes a pitch angle between −5 degrees and +15 degrees relative to a horizontal plane that is oriented perpendicularly relative to a gravity direction.

3. The fitting system of claim 1, wherein the communication means is configured to provide a notification when the pitch angle of the BTE unit is within the threshold range.

4. The fitting system of claim 1, wherein the communication means is configured to indicate a category associated with the pitch angle of the BTE unit.

5. The fitting system of claim 1, wherein the BTE unit further comprises a visual indicator that is configured to indicate when the pitch angle of the BTE unit is within the threshold range.

6. The fitting system of claim 5, wherein the visual indicator comprises a light emitting diode (LED) configured to emit a first light when the BTE unit is positioned relative to the ear such that the pitch angle of the BTE unit is within the threshold range.

7. The fitting system of claim 6, wherein the LED is configured to emit a second light when the BTE unit is positioned relative to the ear such that the pitch angle of the BTE unit is outside of the threshold range.

8. The fitting system of claim 1, wherein the communication means comprises a visual indicator device releasably coupled with the BTE unit.

9. The fitting system of claim 8, wherein the visual indicator device depicts a scale having a plurality of increments aligned along the scale, wherein each increment included in the plurality of increments represents a specific SDS length.

10. The fitting system of claim 8, wherein the BTE unit and the visual indicator device are configured to be rotated together about a pitch axis to position the pitch angle of the BTE device within the threshold range.

11. The fitting system of claim 8, wherein the visual indicator device is releasably coupled with the BTE unit by a releasable coupling formed by a plug-and-socket connection that is configured to functionally connect the BTE unit with the SDS.

12. The fitting system of claim 11, wherein the releasable coupling defines a coupling axis, wherein the releasable coupling is configured such that the visual indicator device is rotatable about the coupling axis.

13. The fitting system of claim 11, wherein the SDS comprises a cable and an electric plug forming a part of the releasable coupling, wherein the electric plug is attached to one end of the cable and the earpiece is attached to an opposite end of the cable.

14. The fitting system of claim 11, wherein the SDS comprises a tubular sound channel and a connector portion forming a part of the releasable coupling, wherein the connector portion is attached to one end of the tubular sound channel and the earpiece that is attached to an opposite end of the tubular sound channel.

15. The fitting system of claim 1, wherein the communication means comprises a user interface communicatively coupled to the processing unit of the BTE unit, the user interface comprising:
one or more processors configured to determine information associated with the pitch angle of the BTE unit, the information including one or more of the pitch angle of the BTE unit, a difference between the pitch angle of the BTE unit and the threshold range, or the target length of the SDS; and
a display device configured to display the information to a hearing care professional (HCP).

16. The fitting system of claim 1, wherein the processing unit is included in the BTE unit.

17. The fitting system of claim 1, wherein the processing unit is separate from the BTE unit.

18. A method comprising:
determining, by a fitting system, when a pitch angle of a behind-the-ear (BTE) unit that is positioned behind an ear of an end user is within a threshold range; and
indicating, by the fitting system, a target length of a sound delivery system (SDS) that is to be configured to connect the BTE unit with an earpiece when worn by the end user by way of a communication means.

19. The method of claim 18, wherein the communication means comprises a visual indicator device releasably coupled with the BTE unit, wherein the visual indicator device depicts a scale having a plurality of increments aligned along the scale, wherein each increment included in the plurality of increments represents a specific SDS length.

20. The method of claim 18, wherein the communication means comprises a user interface communicatively coupled to the BTE unit, wherein the indicating the target length of the SDS includes displaying information associated with the pitch angle of the BTE unit to a hearing care professional (HCP) within the user interface, the information including one or more of the pitch angle of the BTE unit, a difference between the pitch angle of the BTE unit and the threshold range, or the target length of the SDS.
